(19) United States
(12) Patent Application Publication
(10) Pub. No.: US 2012/0281413 A1
(43) Pub. Date: Nov. 8, 2012

(54) Maximum Lumen Plant Growth System

(76) Inventor: Heath J. Lewis, Riverton, WY (US)

(21) Appl. No.: 13/465,984

(22) Filed: May 7, 2012

Related U.S. Application Data
(60) Provisional application No. 61/483,159, filed on May 6, 2011.

(51) Int. Cl. F21V 21/14; F21V 21/00

(52) U.S. Cl. 362/249.11; 362/249.01

(57) ABSTRACT

The present invention has a base, a plurality of posts, a plurality of light rings, a top, a wiring sub-system, and a plurality of artificial lights (preferably LEDs). The base is generally circular in shape and can accommodate a number of different plant pot sizes as plants grow. The plurality of posts is removably attached to the base near its outer perimeter. The posts are designed to hold and support the plurality of light rings. The light rings surround the plant and support the artificial lights. The artificial lights can be LEDs which are placed across the inner surface of the light rings facing inwards towards the center where the plant is located. The top of the system is shaped to attach to the plurality of posts. The top can also accept and hold a second base thereon so that the entire system is stackable.

### CROSS-REFERENCE TO RELATED APPLICATIONS

This application claims the benefit of U.S. Provisional Application No. 61/483,159 entitled MAXIMUM LUMEN PLANT GROWTH SYSTEM, filed May 6, 2011, which is specifically incorporated herein by reference for all that it discloses and teaches.

### TECHNICAL FIELD

This invention relates generally to the horticultural field and, in particular, to a maximum lumen plant growth system utilizing artificial light.

### BACKGROUND

Since the beginnings of civilization, human beings have cultivated plants. Water and sunlight were the two primary resources required, until recently. With the invention of artificial light sources, cultivation of plants relying on photosynthesis could be accomplished without sunlight: the artificial light met the plants' needs. As artificial light sources have been improved and new ones introduced, indoor horticulture using artificial lights has continued to evolve.

However, current indoor horticulture systems have many drawbacks. First, they produce an excessive amount of heat as incandescent lights are notoriously inefficient, often using more electricity to produce heat than light. Second, such systems are often lit only from above causing plants to grow top-heavy and have very scraggly, unproductive bottom portions. Additionally, the spectrum of light reaching the plants can often be sub-optimal in current systems, especially when changing from vegetative growth stages to flowering/fruiting stages. Because of the inefficiencies of current systems, electricity costs are higher than they should be especially when additional cooling systems must be operated to deal with the excessive heat produced by the lighting. Large up-front equipment costs are often necessary to address all these additional problems all while yielding a system that is difficult to adjust for changing plant heights, sizes, spectrums of light for varying growing stages, etc.

Therefore, what is needed is a maximum lumen plant growth system that addresses the above limitations and problems.

### SUMMARY

Embodiments of the present invention described and claimed herein address the foregoing limitations and problems by providing a maximum lumen plant growth system. The present invention comprises at least a base, a plurality of posts, a plurality of light rings, a top, a wiring sub-system, and a plurality of artificial lights (preferably LED lights). Additional components can include swappable posts of various lengths and/or post stackers that allow multiple posts to be placed on top of each other. The base is generally circular in shape and positioned horizontally on the floor. It can accommodate a number of different plant pot sizes for flexibility both in the size of various plant types as well as to allow single plants to be repotted in increasingly larger pots as they grow.

The plurality of posts are removably attached to the base near its outer perimeter. The posts extend upwards, perpendicular to the base. The number of posts may vary, but one embodiment utilizes three. The posts are designed to hold and support the plurality of light rings. The light rings surround the plant (which is placed on the base, near its center) and provide for mounting locations for the plurality of artificial lights. As a plant grows additional light rings and/or posts can be added to extend the system upwards in order to accommodate the plant growth therein.

In a preferred embodiment, the artificial lights are LEDs which are placed across the inner surface of the light rings facing inwards towards the center of the device where the plant is located. The lights are preferably LEDs having the correct wavelength/spectrum for optimum plant growth during vegetative growth phase(s) and a second wavelength/spectrum for optimum fruiting/flowering during that phase of the plant's development. The top of the system is shaped to attach to the plurality of posts. The top can also accept and hold a second base thereon so that the entire system is stackable. Additionally, the top can be concave/dome-shaped on its bottom face so as to reflect light downwards towards the plant. Ventilation holes can be incorporated therein as well.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a maximum lumen plant growth system;

FIG. 2 illustrates a side elevation view of an exemplary embodiment of a maximum lumen plant growth system;

FIG. 3 illustrates a top plan view of an exemplary embodiment of a maximum lumen plant growth system; and

FIG. 4 illustrates a bottom plan view of an exemplary embodiment of a maximum lumen plant growth system.

### DETAILED DESCRIPTION

In one embodiment, a maximum lumen plant growth system comprises at least a base, a plurality of posts, a plurality of light rings, a top, a wiring subsystem, and a plurality of artificial lights (preferably LED lights). Additional components can include swappable posts of various lengths and/or post stackers that allow multiple posts to be placed on top of one another.

In a preferred embodiment, the base is generally circular in shape and positioned horizontally on a floor, counter, table, etc. The base can be other shapes as well, such as square, triangular, quadrilateral, pentagonal, etc. It can accommodate a number of different plant pot sizes for flexibility both in the size of various plant types as well as to allow single plants to be repotted in increasingly larger pots as they grow. An important feature of the base that allows it to be used for multiple sizes of plant pots comprises multiple pot rings. Each pot ring can accommodate a pot with a certain diameter. For example, an inner pot ring might be six inches in diameter, a middle ring eight inches, and an outer ring ten inches. Regardless of the exact measurements and number of rings, the pot rings are placed one inside the other from largest to smallest diameter. In other embodiments, the pot rings are squares, triangles, or any other shape to accommodate pots of those shapes. As each pot ring is slightly depressed in the base relative to the next larger pot ring, a plant placed in the center pot ring would sit slightly lower than a plant placed in the second pot ring, etc.

The base is designed to attach to a plurality of posts. Each post fits in a post cup which holds the post upright, generally perpendicular to the base. Each of the plurality of posts is removably attached to a post cup near the outer perimeter of the base. The number of posts may vary, but one embodiment utilizes three. The posts are designed to hold and support the plurality of light rings.

The light rings surround the plant (which is placed on the base, in approximately its center) and provide for mounting locations for the plurality of artificial lights. The light rings can be any shape including circles, ovals, triangles, quadrilaterals, pentagons, irregular polygons, curved shapes, etc., although the preferred shape is circular. As the plant grows, additional posts and light rings can be added above the original posts in order to accommodate taller plants. The light rings attach to the posts and support the plurality of artificial lights.

In a preferred embodiment, the artificial lights are LEDs which are placed across the inner surface of the light rings facing inwards towards the center of the device where the plant is located. The lights are preferably LEDs having the correct wavelength/spectrum for optimum plant growth during vegetative growth phase(s) and a second wavelength/spectrum for optimum fruiting/flowering during that phase of the plant's development. In another embodiment, the light rings and/or artificial lights are changed as necessary to accommodate the various stages of plant growth rather than incorporating various artificial lights that are brightened/dimmed as needed to provide the optimum intensity, spectrum, wavelengths, etc. of light at the right times.

The top of the system is shaped to attach to the plurality of posts. The top can also accept and hold a second base thereon so that the entire system is stackable. Additionally, the top can be concave/dome-shaped on its bottom face and can incorporate light-reflective material(s) so as to reflect light downwards towards the plant. Ventilation holes can be incorporated therein as well. The top can utilize a channel in the shape of the base that can accept a second base therein to facilitate structural stability when stacking multiple systems on top of each other.

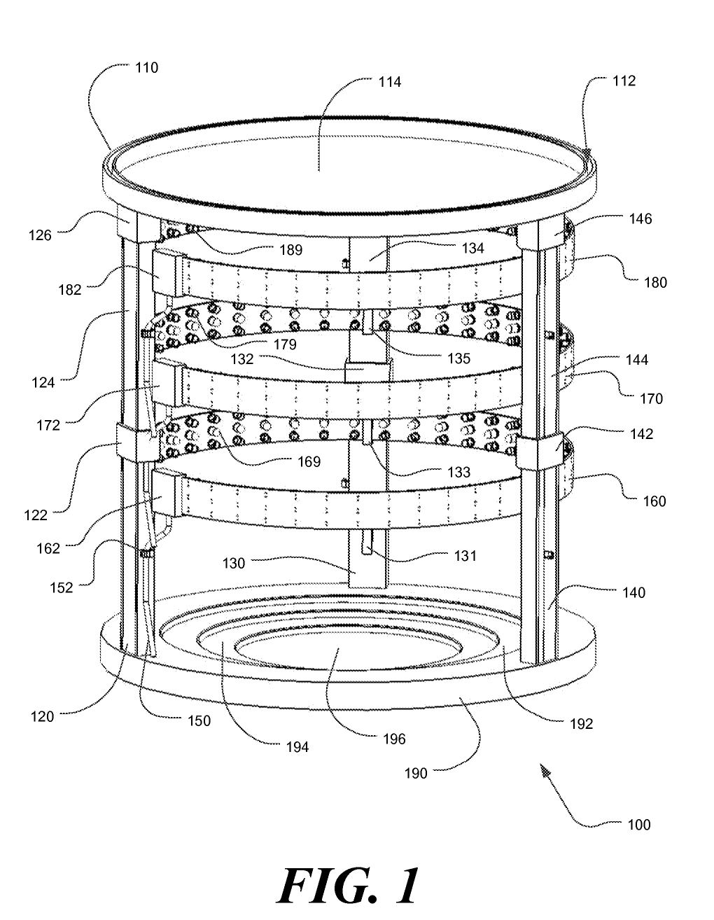

FIG. 1 illustrates a perspective view of an exemplary embodiment of a maximum lumen plant growth system 100. The system has a base 190; a top 110; a plurality of posts 120, 130, and 140; a plurality of light rings 160, 170, and 180; a wiring subsystem 150; and a plurality of artificial lights 169, 179, and 189.

In a preferred embodiment, the base 190 is generally circular in shape, but it can be other shapes as well, such as square, triangular, quadrilateral, pentagonal, etc. In yet other embodiments, the base 190 can be irregular polygonal shapes, curved shapes, etc. as long as it can still hold a plant pot and support the plurality of posts. The base can accommodate a number of different plant pot sizes for flexibility both in the size of various plant types as well as to allow single plants to be repotted in increasingly larger pots as they grow. An important feature of the base that allows it to be used for multiple sizes of plant pots comprises multiple pot rings 192, 194, and 196. Each pot ring can accommodate a pot with a certain diameter. For example, an inner pot ring 196 might be six inches in diameter, a middle ring 194 eight inches, and an outer ring 192 ten inches. Regardless of the exact measurements and number of rings 192, 194, and 196, the pot rings 192, 194, and 196 are placed one inside the other from largest to smallest diameter. In other embodiments, the pot rings 192, 194, and 196 are squares, triangles, or any other shape to accommodate pots of those shapes. As each pot ring 192, 194, and 196 is slightly depressed in the base relative to the next larger pot ring 192, 194, and 196, a plant placed in the center pot ring 196 would sit slightly lower than a plant placed in the second pot ring 194, etc.

The base 190 is designed to attach to a plurality of posts 120, 130, and 140. Each post 120, 130, and 140 fits in a post cup which holds the post upright, generally perpendicular to the base 190. Each of the plurality of posts 120, 130, and 140 is removably attached to a post cup near the outer perimeter of the base 190. The number of posts 120, 130, and 140 may vary, but one embodiment utilizes three. The posts 120, 130, and 140 are designed to hold and support the plurality of light rings 160, 170, and 180.

As the plant continues to grow and get taller, it may become necessary to extend the height of the system 100. This can be accomplished by taking the plurality of posts 120, 130, and 140 and attaching to them a second plurality of posts 124, 134, and 144 via post stackers 122, 132, and 142. The stackers 122, 132, and 142 allow the tops of the first plurality of posts 120, 130, and 140 to be attached to the bottoms of a second plurality of posts 124, 134, and 144. In such a way, multiple courses of posts can be stacked one on top of the next. As the plant grows, additional courses of posts can be added as needed to accommodate the height of the plant. It should be apparent that each new course of posts can hold one or more additional light rings as well. A support ring can be added as needed to buttress the courses of posts in order to keep them upright and structurally sound as more are added.

The posts 120, 130, 140, 124, 134, and 144 each accommodate a plurality of clip attachments 131, 133, and 135. In the embodiment shown in FIG. 1, there are two clips 131 and 133 per post 130 (clip 135 and clip 137, not shown, are on a second, stacker post 134). In other embodiments, the number of clips can be less than or greater than two. The clips 131, 133, and 135 provide an attachment means between the light rings 160, 170, and 180 and the posts.

The light rings 160, 170, and 180 surround the plant (which is placed on the base 190, in approximately its center) and provide for mounting locations for the plurality of artificial lights 169, 179, and 189. The light rings 160, 170, and 180 can be any shape including circles, ovals, triangles, quadrilaterals, pentagons, irregular polygons, curved shapes, etc., although the preferred shape is circular. Being generally ring shaped, the light rings 160, 170, and 180 necessarily incorporate an interior hollow through which the plant can grow upwards. The light rings 160, 170, and 180 can be made of semi-rigid circuit board, or they can be configured in some other manner. The light rings 160, 170, and 180 attach to the posts 120, 130, 140, 124, 134, and 144 via a plurality of clip attachments 131, 133, and 135. The clips 131, 133, and 135 can be a simple bracket attached to the post that has a vertical channel in which the light ring can be positioned. In other embodiments, other types of clip attachments 131, 133, and 135 are contemplated.

As the plant grows in diameter, different diameter light rings can be substituted in or added to the system. For example, the middle of a plant could continue to expand outwards as the plant grows, necessitating light rings with larger diameters. If the system 100 were initially built with, for example, a thirty inch diameter base, initial light ring diameters could be ten inches (reducers could be placed between the posts and the light rings and/or clips to span the distance from the posts to the reduced diameter light rings. Then, as the plant grew, fourteen inch diameter rings could be employed (with reducers of lesser length); followed by eighteen inch, twenty two inch, twenty six inch, and finally approximately twenty nine inch diameter light rings (which would need no reducers). In another embodiment, if the light ring attached to the outside of the posts, thirty inch light rings could attach directly to the posts. Additionally, the system 100 could be configured with light rings that are larger in diameter than the base simply by placing extenders between the large-diameter light rings and the posts.

In a preferred embodiment, the artificial lights 169, 179, and 189 are LEDs which are placed across the inner surface of the light rings 160, 170, and 180 facing inwards towards the center of the device where the plant is located. The lights 169, 179, and 189 are preferably LEDs having the correct wavelength/spectrum for optimum plant growth during vegetative growth phase(s) and a second wavelength/spectrum for optimum fruiting/flowering during that phase of the plant's development. In another embodiment, the light rings 160, 170, and 180 and/or artificial lights 169, 179, and 189 are changed as necessary to accommodate the various stages of plant growth rather than incorporating various artificial lights 169, 179, and 189 that are brightened/dimmed as needed to provide the optimum intensity, spectrum, wavelengths, etc. of light at the right times. The lights 169, 179, and 189 can be surface mounted on the rings 160, 170, and 180 or they can be thru-hole mounted. In a preferred embodiment, the light rings 160, 170, and 180 are spaced vertically from each other a minimum distance in order to allow for ventilation and viewing/access to the plant.

The top 110 of the system is shaped to attach to the plurality of posts 120, 130, and 140. The top 110 can also accept and hold a second base thereon so that the entire system 100 is stackable. This is accomplished via the support ring 112 that is incorporated into the top 110. The support ring 112 comprises a channel in which the outer diameter of the base 190 can be inserted. The support ring 112 securely holds the second base and provides the support necessary for stacking of multiple systems 100 one on top of the next. Additionally, the top 110 can be concave/dome-shaped on its bottom face and can incorporate light-reflective material(s) so as to reflect light downwards towards the plant. Although not shown in FIG. 1, the main body 114 of the top 110 can include ventilation holes therein to allow for heat/air to escape therethrough.

A wiring subsystem 150 is included in the maximum lumen plant growth system 100. The wiring subsystem 150 includes the necessary wiring to power the plurality of lights 169, 179, and 189 in the light rings 160, 170, and 180. Lighting controller boxes 162, 172, and 182 are shown in FIG. 1 to control and distribute power to each light ring 160, 170, and 180. The wiring subsystem 150 can be run up the outside of a post as shown in FIG. 1 using the cable management clasps 152, or it can be strung internally through one or more posts as needed. Although not shown in FIG. 1, the wiring subsystem 150 includes a power attachment that can be in the form of a plug, powerstrip, or direct wiring in order to distribute electricity from some external system into the maximum lumen plant growth system 100.

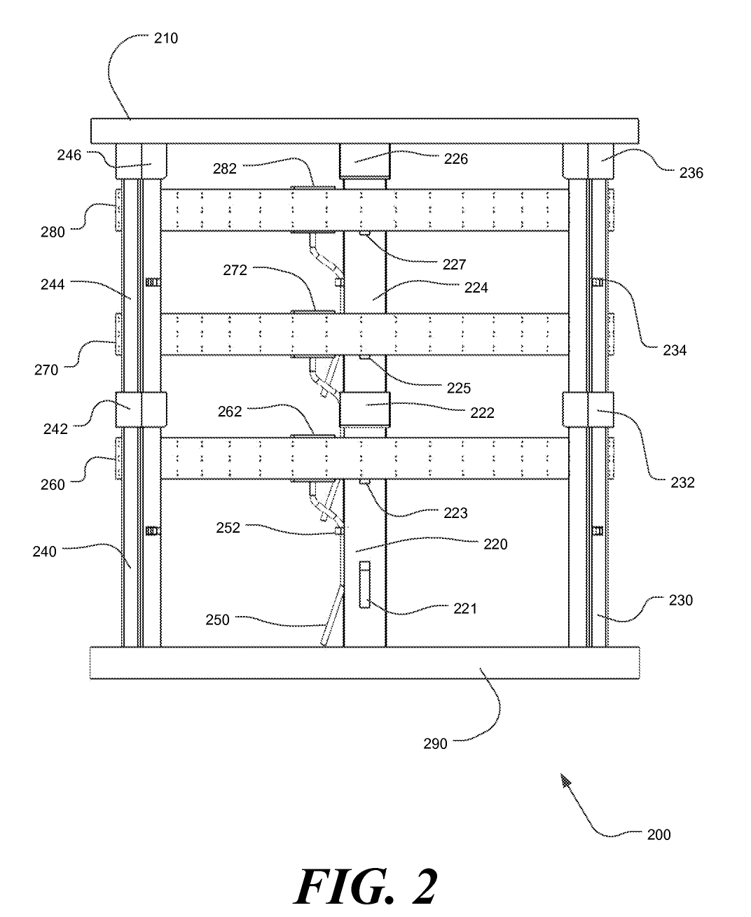

FIG. 2 illustrates a side elevation view of an exemplary embodiment of a maximum lumen plant growth system 200. Components illustrated in FIG. 1 are also shown in FIG. 2, including: the base 290; the top 210; the plurality of posts 220, 224, 230, 234, 240, and 244; the post stackers 222, 232, and 242; the light rings 260, 270, and 280; controller boxes 262, 272, and 282; clips 221, 223, 225, and 227; wiring subsystem 250; and cable management clasps 252. Also shown in FIG. 2 are the post receivers 226, 236, and 246 attached to the bottom side of the top 210 for receiving the tops of posts therein.

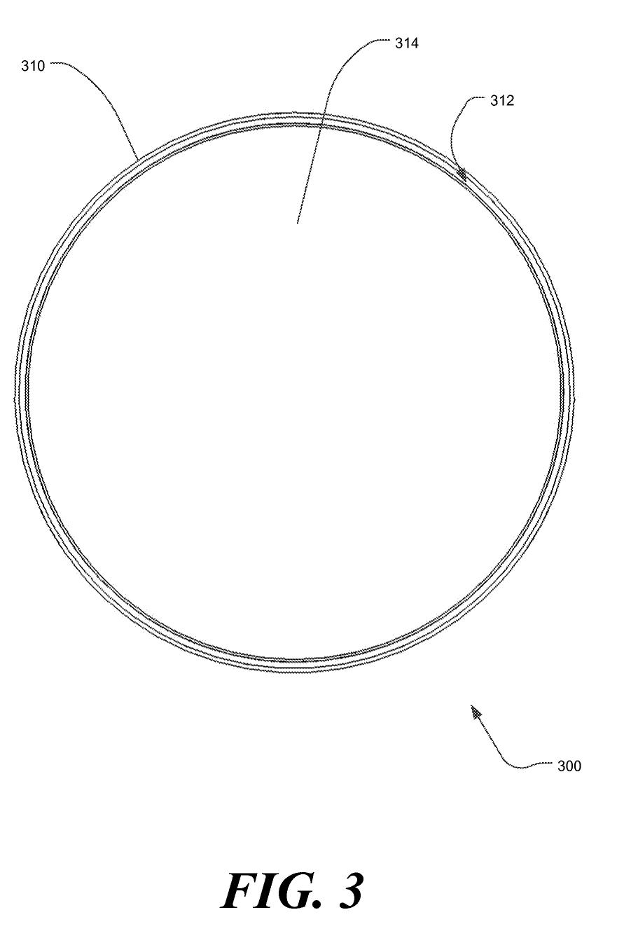

FIG. 3 illustrates a top plan view of an exemplary embodiment of a maximum lumen plant growth system 300 highlighting the top 310, the support ring 312, and the main body 314 of the top 310. The support ring 312 comprises a channel in which the outer diameter of the base 190 can be inserted. The support ring 312 securely holds a second base and provides the support necessary for stacking of multiple systems 300, one on top of the next. Although not shown in FIG. 3, the main body 314 of the top 310 can include ventilation holes therein to allow for heat/air to escape therethrough.

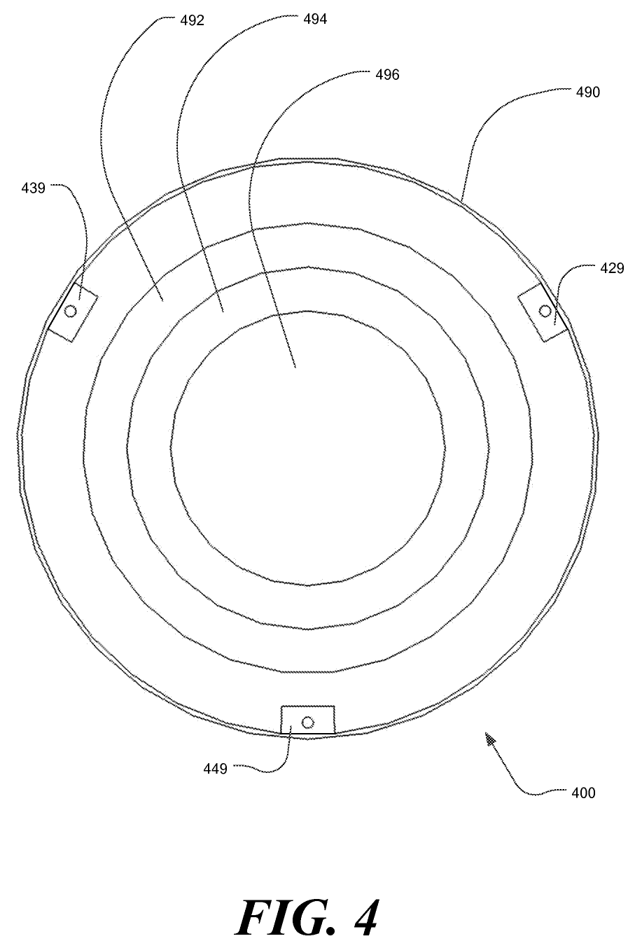

FIG. 4 illustrates a bottom plan view of an exemplary embodiment of a maximum lumen plant growth system 400. The bottom face of the base 490 is highlighted showing the various pot rings 496, 494, and 492 of increasing diameters, as well as the post cups 429, 439, and 449. The post cups 429, 439, and 449 are a plurality of post attachments. They accept the bottoms of the posts and lock them in place vertically to support the light rings and the entire structure. Other post attachments are contemplated.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary embodiments of the described articles of manufacture and methods. Many embodiments can be made without departing from the spirit and scope of the invention.

What is claimed is:

1. A maximum lumen plant growth system, comprising:
a base being generally flat and incorporating a plurality of post attachments;
a first plurality of posts each having a bottom end and a top end and wherein the bottom end of each post is removably attached to the base by the post attachment;
a top, wherein the top end of each post is removably attached to the top via one of a plurality of post receivers;
a plurality of light rings shaped so as to extend between the posts and attach thereto via a first plurality of clip attachments, the plurality of light rings being generally ring-shaped so as to have an interior hollow through which a plant can grow, and wherein the plurality of light rings are positioned above the base and in planes generally parallel thereto;
a wiring subsystem configured to attach to a power source and distribute electricity from the source to a plurality of artificial lights; and
the plurality of artificial lights configured on an interior surface of each of the plurality of light rings and facing inwards such that when activated the plurality of artificial lights shine inwards towards the interior hollow.

2. The maximum lumen plant growth system of claim 1 further comprising:
the base having a plurality of pot rings, the pot rings sized to match a plurality of pots such that progressively larger pots can be used within the system as a plant grows.

3. The maximum lumen plant growth system of claim 1 further comprising:
a second plurality of posts;
the second plurality of posts each having a lower end and an upper end;
wherein the lower end of each of the second plurality of posts is removably attached to a post stacker;
wherein the top end of each of the first plurality of posts is removably attached to a post stacker; and
wherein the upper end of each of the second plurality of posts is removably attached to the top via one of a plurality of post receivers.

4. The maximum lumen plant growth system of claim 2 further comprising:
a second plurality of posts;
the second plurality of posts each having a lower end and an upper end;
wherein the lower end of each of the second plurality of posts is removably attached to a post stacker;
wherein the top end of each of the first plurality of posts is removably attached to a post stacker; and
wherein the upper end of each of the second plurality of posts is removably attached to the top via one of a plurality of post receivers.

5. The maximum lumen plant growth system of claim 1 further comprising:
wherein at least one of each clip attachment is attached to each post and has a vertical channel therein configured to accept a portion of one of the plurality of light rings in order to removably attach the light ring to the post.

6. The maximum lumen plant growth system of claim 2 further comprising:
wherein at least one of each clip attachment is attached to each post and has a vertical channel therein configured to accept a portion of one of the plurality of light rings in order to removably attach the light ring to the post.

7. The maximum lumen plant growth system of claim 3 further comprising:
wherein at least one of each clip attachment is attached to each post and has a vertical channel therein configured to accept a portion of one of the plurality of light rings in order to removably attach the light ring to the post.

8. The maximum lumen plant growth system of claim 1 wherein the top has a support ring incorporated therein and wherein the support ring comprises a channel in which an outer diameter of a second base can be inserted to securely hold the second base and provide a support necessary to stack a second system on the top.

9. A maximum lumen plant growth system, comprising:
a base being generally flat and incorporating a plurality of post attachments;
the base having a plurality of pot rings, the pot rings sized to match a plurality of pots such that progressively larger pots can be used within the system as a plant grows;
a top;
a first plurality of posts each having a bottom end and a top end and wherein the bottom end of each post is removably attached to the base by the post attachment;
a second plurality of posts each having a lower end and an upper end and wherein the lower end of each post is removably attached to a post stacker;
wherein the top of each of the first plurality of posts is removably attached to a post stacker;
wherein the upper end of each of the second plurality of posts is removably attached to the top via one of a plurality of post receivers;
a plurality of light rings shaped so as to extend between the posts and attach thereto via a first plurality of clip attachments, the plurality of light rings being generally ring-shaped so as to have an interior hollow through which a plant can grow, and wherein the plurality of light rings are positioned above the base and in planes generally parallel thereto;
a wiring subsystem configured to attach to a power source and distribute electricity from the source to a plurality of artificial lights; and
the plurality of artificial lights configured on an interior surface of each of the plurality of light rings and facing inwards such that when activated the plurality of artificial lights shine inwards towards the interior hollow.

10. The maximum lumen plant growth system of claim 9 further comprising:
wherein at least one of each clip attachment is attached to each post and has a vertical channel therein configured to accept a portion of one of the plurality of light rings in order to removably attach the light ring to the post.

11. The maximum lumen plant growth system of claim 10 wherein the top has a support ring incorporated therein and wherein the support ring comprises a channel in which an outer diameter of a second base can be inserted to securely hold the second base and provide a support necessary to stack a second system on the top.
